(19) United States
(12) Patent Application Publication
(10) Pub. No.: US 2016/0071159 A1
(43) Pub. Date: Mar. 10, 2016

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Seiya INAGI, Kanagawa (JP); Masahiro SATO, Kanagawa (JP)

(21) Appl. No.: 14/615,838

(22) Filed: Feb. 6, 2015

(30) Foreign Application Priority Data
Sep. 4, 2014 (JP) 2014-179886

(51) Int. Cl. G06Q 30/02; G06F 17/30

(52) U.S. Cl. CPC G06Q 30/0269; G06F 17/30699

(57) ABSTRACT

A non-transitory computer readable medium stores a program causing a computer to execute a process for presenting information. The process includes extracting text information for each of multiple shops from introductory information about the shops from a predetermined viewpoint; calculating a feature value for each of the shops from the extracted text information; and presenting information about the shops in accordance with presentation order based on the calculated feature values.

### CROSS-REFERENCE TO RELATED APPLICATIONS

This application is based on and claims priority under 35 USC 119 from Japanese Patent Application No. 2014-179886 filed Sep. 4, 2014.

### BACKGROUND

### Technical Field

The present invention relates to an information processing apparatus and a non-transitory computer readable medium.

As a technique of the related art, an information processing apparatus has been disclosed in which, on the basis of preference information registered by a user, information registered by other users having similar preferences is displayed.

### SUMMARY

According to an aspect of the invention, there is provided a non-transitory computer readable medium storing a program causing a computer to execute a process for presenting information. The process includes extracting text information for each of multiple shops from introductory information about the shops from a predetermined viewpoint; calculating a feature value for each of the shops from the extracted text information; and presenting information about the shops in accordance with presentation order based on the calculated feature values.

### BRIEF DESCRIPTION OF THE DRAWINGS

Exemplary embodiments of the present invention will be described in detail based on the following figures, wherein:

FIG. 1 is a schematic view of an exemplary configuration of an information processing system according to an exemplary embodiment;

FIG. 2 is a block diagram illustrating an exemplary configuration of an information processing apparatus according to the exemplary embodiment;

FIGS. 3A and 3B are diagrams for describing an operation of registering food ingredient names;

FIGS. 4A and 4B are diagrams for describing an operation of calculating a feature value from restaurant introduction information and generating feature-value information;

FIGS. 5A and 5B are diagrams for describing an operation of calculating a feature value from user-visit history information and generating feature-value information; and

FIG. 6 is a schematic view of an exemplary configuration of a screen for presenting search results on the basis of inputted search words.

### DETAILED DESCRIPTION

### Exemplary Embodiment

### Configuration of Information Processing System

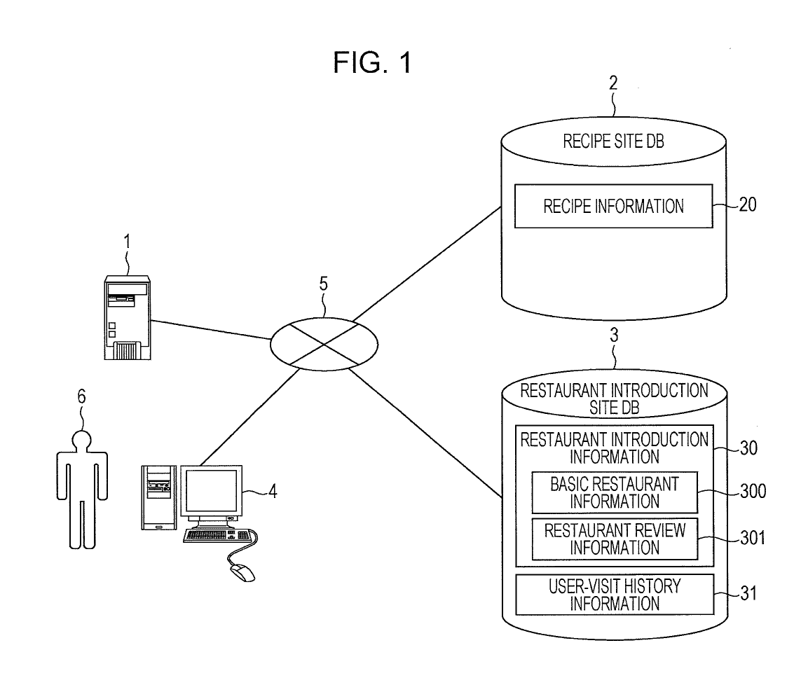

FIG. 1 is a schematic view of an exemplary configuration of an information processing system according to an exemplary embodiment.

The information processing system has a configuration in which an information processing apparatus 1, a recipe site DB 2, a restaurant introduction site DB 3, and a terminal 4 are communicatively connected to one another through a network 5. The terminal 4 is operated by a user 6. Services provided by the information processing apparatus 1, the recipe site DB 2, and the restaurant introduction site DB 3 in the information processing system may be supplied by a single company, or may be supplied by individual companies.

The information processing apparatus 1 which functions as a server operates in response to a request from the terminal 4, and includes electronic components, such as a central processing unit (CPU) having functions for processing information and a flash memory, in the main body thereof. In response to a request, the information processing apparatus 1 transmits information about recommendation of restaurants to the user 6 using the terminal 4.

The recipe site DB 2 which is a database for recipe sites for introducing cooking recipes stores recipe information 20 about cooking recipes. An exemplary recipe site is “COOKPAD”®.

The restaurant introduction site DB 3 which is a database for sites for introducing restaurants with user reviews includes restaurant introduction information 30 in which information for introducing restaurants is associated, and user-visit history information 31 representing a history of visits of users to restaurants. The restaurant introduction information 30 includes basic restaurant information 300 in which each of the restaurants is associated with introduction information of the restaurant (for example, information about selling points, a menu, access information, the number of seats, and the like of the restaurant), and restaurant review information 301 in which each of the restaurants is associated with reviews posted by multiple users. The user-visit history information 31 does not have to include information about actual visits of users to restaurants. For example, the user-visit history information 31 may utilize restaurant pages registered in Favorites, and a history of visits of users to restaurant introduction pages in restaurant introduction sites. Examples of a restaurant introduction site include “Gurunabi”®, “Tabelogu”®, and “Yelp”®.

The terminal 4 which is an information processing apparatus such as a personal computer (PC) includes electronic components, such as a CPU having functions for processing information and a flash memory, in the main body thereof.

The network 5 which is a communication network which is capable of performing fast communication is, for example, a wired or wireless communication network, such as an intranet or a local area network (LAN).

### Configuration of Information Processing Apparatus

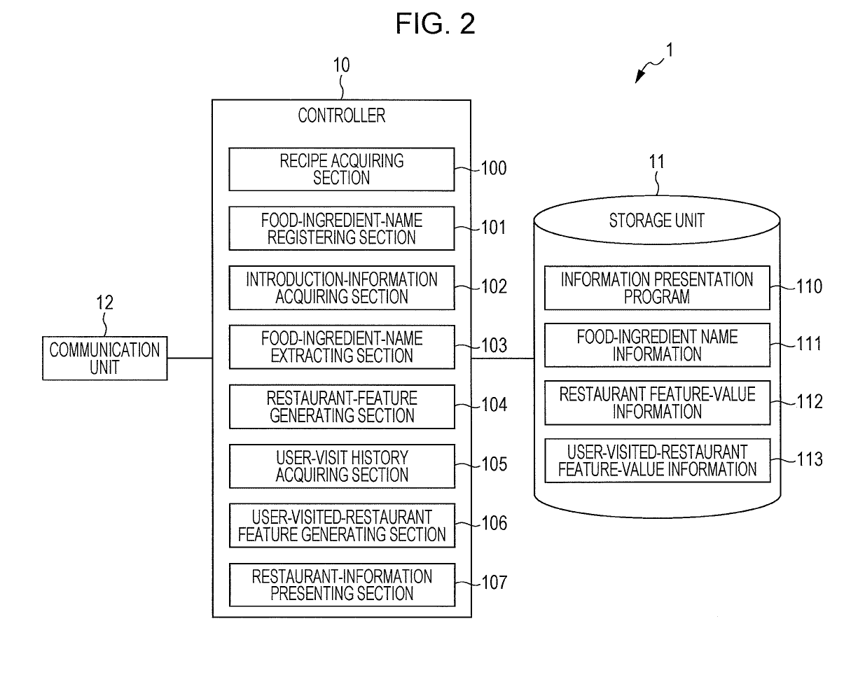

FIG. 2 is a block diagram illustrating an exemplary configuration of the information processing apparatus 1 according to the exemplary embodiment.

The information processing apparatus 1 including a CPU controls units and includes a controller 10 which executes various programs, a storage unit 11 which is constituted by a storage medium such as a flash memory and which stores information, and a communication unit 12 which communicates with the outside via the network.

The controller 10 executes an information presentation program 110 described below, thereby functioning as, for example, a recipe acquiring section 100, a food-ingredient-name registering section 101, an introduction-information acquiring section 102, a food-ingredient-name extracting section 103, a restaurant-feature generating section 104, a user-visit history acquiring section 105, a user-visited-restaurant feature generating section 106, and a restaurant-information presenting section 107.

The recipe acquiring section 100 acquires the recipe information 20 from the recipe site DB 2 via the communication unit 12.

The food-ingredient-name registering section 101 extracts food ingredient names (second food ingredient names) from the recipe information 20 acquired by the recipe acquiring section 100, and registers them in the storage unit 11 as food-ingredient name information 111. A food ingredient name is an exemplary viewpoint, and “taste” or the like may be extracted as another viewpoint. In addition, “dish name”, “food genre”, or the like which is a broader concept of “food ingredient” or “taste” may be extracted as a viewpoint.

The introduction-information acquiring section 102 acquires the restaurant introduction information 30 from the restaurant introduction site DB 3 via the communication unit 12. As the restaurant introduction information 30, either one of the basic restaurant information 300 and the restaurant review information 301 may be used, or both of them may be used.

The food-ingredient-name extracting section 103 extracts food ingredient names (text information, first food ingredient names) corresponding to the registered food-ingredient name information 111, as an exemplary viewpoint from the restaurant introduction information 30 acquired by the introduction-information acquiring section 102. Similarly to the food-ingredient-name registering section 101, the food-ingredient-name extracting section 103 may extract text information corresponding to “taste” or the like as another viewpoint. In addition, text information corresponding to a viewpoint, such as “dish name” or “food genre”, which is a broader concept of “food ingredient” or “taste” may be extracted.

As an exemplary viewpoint, access information (restaurant location) may be extracted from the basic restaurant information 300. When the level of “X city” is used as a base for a broader concept or a narrower concept of access information, text information corresponding to a prefecture or the like may be extracted as a broader concept, and text information corresponding to a street, a house number, or the like may be extracted as a narrower concept. As an exemplary viewpoint, the number of seats may be extracted from the basic restaurant information 300.

The restaurant-feature generating section 104 calculates a feature value for each of the restaurants on the basis of the food ingredient names extracted by the food-ingredient-name extracting section 103, and generates restaurant feature-value information 112. It is only required that the restaurant feature-value information 112 include at least the feature value and information about the restaurant name. The restaurant feature-value information 112 may further include other information such as food ingredient names. The calculation of a feature value may be performed for each of the restaurants in terms of a food genre which is a broader concept of a food ingredient name. The calculation of a feature value will be described below.

The user-visit history acquiring section 105 acquires the user-visit history information 31 from the restaurant introduction site DB 3 via the communication unit 12.

The user-visited-restaurant feature generating section 106 extracts restaurants visited by each of the users from the user-visit history information 31 acquired by the user-visit history acquiring section 105. The user-visited-restaurant feature generating section 106 generates the user-visited-restaurant feature-value information 113 from the feature values of the extracted restaurants. It is only required that the user-visited-restaurant feature-value information 113 include at least the feature value and information about the user. The user-visited-restaurant feature-value information 113 may further include information about the visited restaurants.

When multiple restaurants are extracted, a feature value obtained by integrating their feature values may be used.

The restaurant-information presenting section 107 presents information about restaurants suiting preferences of the user on the basis of the restaurant feature-value information 112 and the user-visited-restaurant feature-value information 113. As information about a restaurant, a restaurant name, photographs of the restaurant, contact information, access information, an average payment, and the like may be used. Therefore, it is not necessary to present the basic restaurant information 300 and the restaurant review information 301 to the user.

The storage unit 11 stores, for example, the information presentation program 110, using which the controller 10 functions as the units 100 to 107 described above, the food-ingredient name information 111, the restaurant feature-value information 112, and the user-visited-restaurant feature-value information 113.

### Operations Performed by Information Processing Apparatus

Operations according to the present exemplary embodiment will be described by separating the operations into (1) a basic operation, (2) an operation of registering food ingredient names, (3) an operation of generating feature-value information, (4) a first presenting operation, and (5) a second presenting operation.

### (1) Basic Operation

When the user 6 visits a restaurant and eats a meal, the user 6 operates the terminal 4 to access the restaurant introduction site DB 3 and post a review of the visited restaurant. When the review of the restaurant is posted, the restaurant introduction information 30 and the user-visit history information 31 are updated in the restaurant introduction site DB 3.

Another user posts a recipe to the recipe site DB 2, and the recipe information 20 is updated.

### (2) Operation of Registering Food Ingredient Names

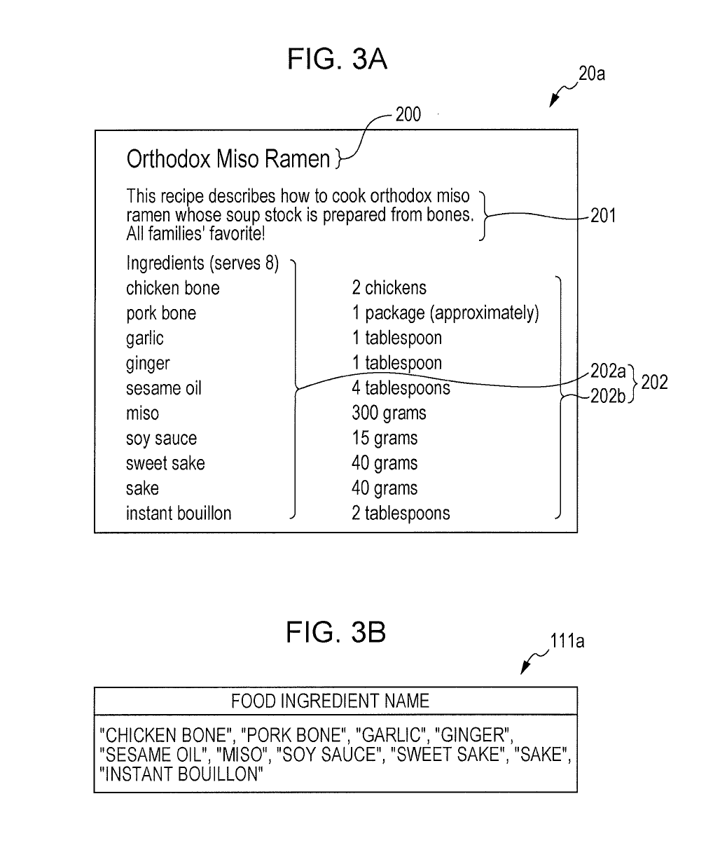

FIGS. 3A and 3B are diagrams for describing an operation of registering food ingredient names.

The recipe acquiring section 100 of the information processing apparatus 1 acquires recipe information 20a from the recipe site DB 2 via the communication unit 12. The recipe information 20a is exemplary recipe information 20. As illustrated in FIG. 3A, the recipe information 20a includes a recipe title 200, a recipe description 201, and ingredient information 202. The ingredient information 202 includes ingredient name information 202a and food-ingredient-quantity information 202b.

The food-ingredient-name registering section 101 extracts the ingredient name information 202a serving as the second food ingredient names, as an exemplary viewpoint from the recipe information 20a acquired by the recipe acquiring section 100. As illustrated in FIG. 3B, the food-ingredient-name registering section 101 registers it as food-ingredient name information 111a in the storage unit 11. When the recipe information 20a is generated in a predetermined format, the ingredient name information 202a may be extracted from a predetermined area in the format. Alternatively, unregistered words may be extracted from an area in which words registered in advance as a food ingredient name are detected. In this example, “chicken bone”, “pork bone”, “garlic”, “ginger”, “sesame oil”, “miso”, “soy sauce”, “sweet sake”, “sake”, and “instant bouillon” are extracted and registered.

### (3) Operation of Generating Feature-Value Information

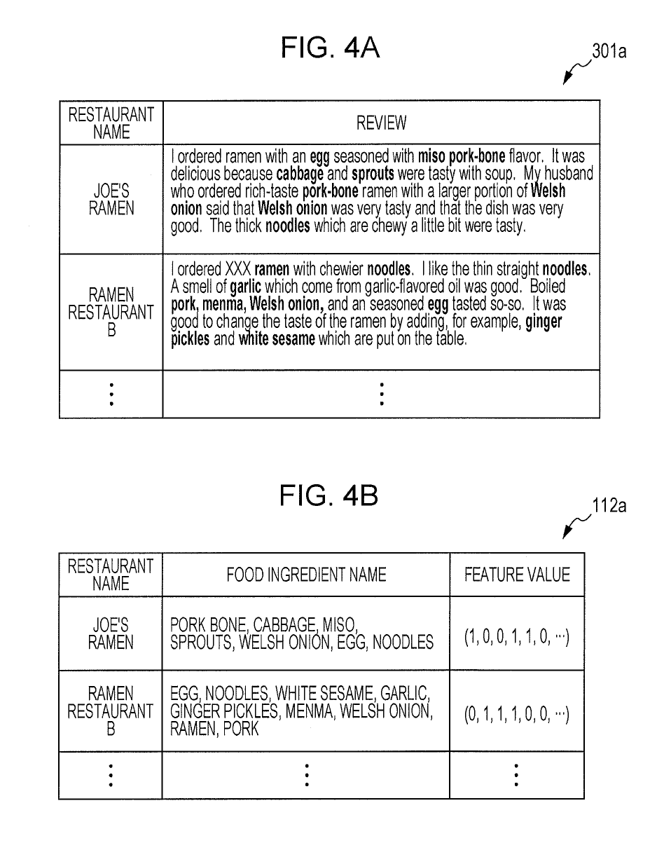

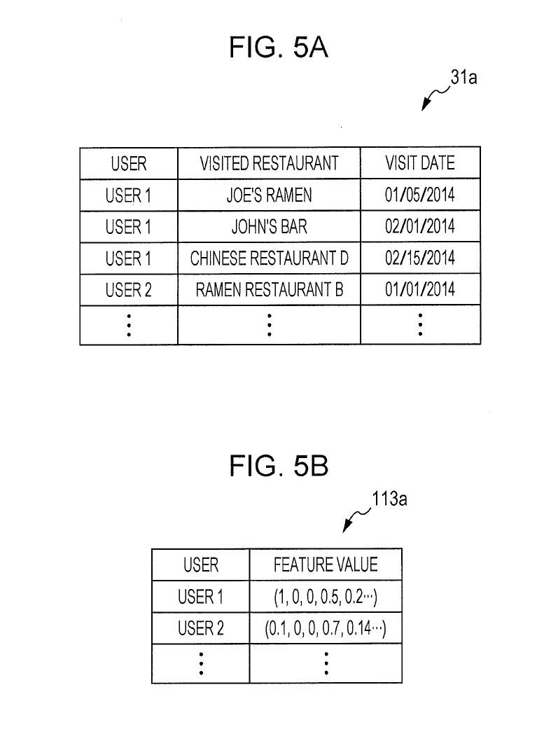

FIGS. 4A and 4B are diagrams for describing an operation of calculating a feature value from the restaurant introduction information 30 and generating feature-value information. FIGS. 5A and 5B are diagrams for describing an operation of calculating a feature value from the user-visit history information 31 and generating feature-value information.

The introduction-information acquiring section 102 acquires the restaurant introduction information 30 from the restaurant introduction site DB 3 via the communication unit 12. The case in which restaurant review information 301a is used as the restaurant introduction information 30 is illustrated. The restaurant review information 301a which is exemplary restaurant review information 301 includes restaurant names and reviews, as illustrated in FIG. 4A.

The food-ingredient-name extracting section 103 extracts food ingredient names (first food ingredient names) as an exemplary viewpoint from reviews in the restaurant review information 301a acquired by the introduction-information acquiring section 102.

The restaurant-feature generating section 104 generates restaurant feature-value information 112a from feature values predetermined for the extracted food ingredient names, as illustrated in FIG. 4B, and stores it in the storage unit 11.

In this example, the food-ingredient-name extracting section 103 extracts food ingredients “miso”, “pork bone”, “egg”, “cabbage”, “sprouts”, “Welsh onion”, and “noodles” from the review for a restaurant whose name is “Joe's Ramen”. The restaurant-feature generating section 104 integrates feature values predetermined for the food ingredients “miso”, “pork bone”, “egg”, “cabbage”, “sprouts”, “Welsh onion”, and “noodles”, and extracts a feature value of the restaurant “Joe's Ramen”.

An exemplary method for calculating a feature value by the food-ingredient-name extracting section 103 is bag-of-words. In bag-of-words, a vector whose dimensionality is equal to the number of food ingredient types included in all of the reviews is generated as a feature value. This vector is generated for each restaurant, and each element of the vector is determined depending on whether or not the corresponding food ingredient name is included in reviews for the restaurant. In the example in FIG. 4B, an element which corresponds to “pork bone” and which is in a vector serving as a feature value of “Joe's Ramen” is set to “1” because “pork bone” is included in a review for “Joe's Ramen”; and an element corresponding to “menma” is set to “0” because “menma” is not included in a review for “Joe's Ramen”. The value of each element may be binary data, 0 or 1, or may be a value obtained, for example, by assigning a weight on the basis of the number of occurrences. Instead of bag-of-words, for example, a method in which each element reflects meaning information of the word (see “Efficient estimation of word representations in vector space”, Tomas Mikolov, Kai Chen, Greg Corrado, and Jeffrey Dean, ICLR Workshop, 2013) may be used.

The food-ingredient-name extracting section 103 extracts the food ingredients “noodles”, “garlic”, “pork”, “menma”, “Welsh onion”, “egg”, “ginger pickles”, and “white sesame” from reviews for a restaurant whose name is “Ramen Restaurant B”. The restaurant-feature generating section 104 integrates feature values predetermined for the food ingredients “noodles”, “garlic”, “pork”, “menma”, “Welsh onion”, “egg”, “ginger pickles”, and “white sesame”, and calculates a feature value of the restaurant “Ramen Restaurant B”.

The user-visit history acquiring section 105 acquires user-visit history information 31a from the restaurant introduction site DB 3 via the communication unit 12. The user-visit history information 31a is exemplary user-visit history information 31, and includes users, the names of restaurants visited by the users, and visit dates, as illustrated in FIG. 5A.

The user-visited-restaurant feature generating section 106 extracts restaurants visited by each of the users, from the user-visit history information 31a acquired by the user-visit history acquiring section 105, and extracts a feature value obtained by integrating the feature value of at least one restaurant. As illustrated in FIG. 5B, the user-visited-restaurant feature generating section 106 stores it in the storage unit 11 as user-visited-restaurant feature-value information 113a. For example, the user-visited-restaurant feature generating section 106 extracts an average of the feature values of restaurants as an integrated feature value.

In this example, “user 1” visited restaurants “Joe's Ramen”, “John's Bar”, and “Chinese Restaurant D”. Accordingly, each of the feature values of the restaurants whose names are “Joe's Ramen”, “John's Bar”, and “Chinese Restaurant D” is obtained from the restaurant feature-value information 112, and an average of the feature values is calculated, whereby a feature value of “user 1” is extracted. In addition, “user 2” visited restaurants such as “Ramen Restaurant B”. Accordingly, the features values of the restaurants such as “Ramen Restaurant B” are integrated from the restaurant feature-value information 112, whereby a feature value of “user 2” is extracted.

(4) First Presenting Operation

As an exemplary presenting operation, the restaurant-information presenting section 107 presents information about restaurants without using the user-visited-restaurant feature-value information 113.

The restaurant-information presenting section 107 receives a request to present information about restaurants from the user 6. When the request is received, location information such as “Kanagawa” and a product genre such as “Ramen” are received as exemplary search keywords.

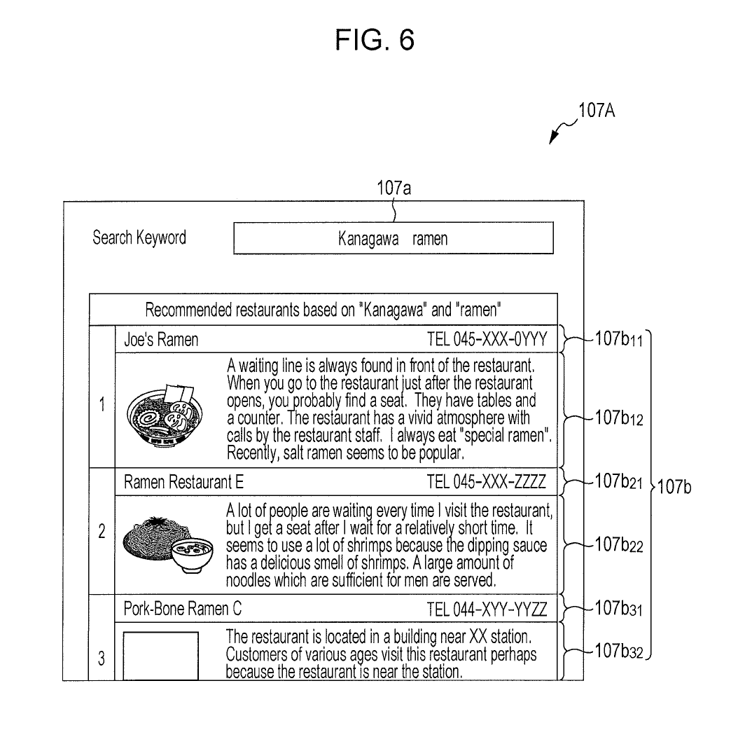

FIG. 6 is a schematic view of an exemplary configuration of a screen on which search results are presented on the basis of the inputted search words.

A restaurant presentation screen 107A is a screen which is subjected to display processing by the restaurant-information presenting section 107 and which is displayed on a display unit of the terminal 4. The restaurant presentation screen 107A displays a search-keyword input field 107a for receiving input of search keywords, and search result information 107b which is information about restaurants obtained through searching based on the search keywords. As the search result information 107b, the basic restaurant information 300 for each of the restaurants, and information 107b₁₁, information 107b₁₂, information 107b₂₁, information 107b₂₂, information 107b₃₁, and information 107b₃₂ which are extracted from the restaurant review information 301 are displayed.

The information 107b₁₁, the information 107b₁₂, the information 107b₂₁, the information 107b₂₂, the information 107b₃₁, and the information 107b₃₂ are arranged on the basis of a predetermined criterion. For example, by using the feature-value information for each of the restaurants registered in a restaurant introduction site, if the feature-value information of a first restaurant is close to that of a second restaurant, information about the restaurants is arranged so that the information about the first restaurant is presented at a position close to that of the information about the second restaurant.

To calculate closeness of feature values, for example; a method employing a distance between any two feature value vectors in a feature space or employing cosine similarity may be used. Expression (1) or (2) is used to calculate closeness of two feature values x.

$$\begin{matrix}l = \vert {x}_{1} - {x}_{2} \vert & ( 1 ) \\ cos ( {x}_{1} , {x}_{2} ) = \frac{{x}_{1} \cdot {x}_{2}}{\vert {x}_{1} \vert \vert {x}_{2} \vert} & ( 2 )\end{matrix}$$

The order in presentation of the search result information 107b may be descending order of evaluation information for restaurants, or may be such that information about a restaurant having a contract with a restaurant introduction site to have priority for display is displayed with high priority. Alternatively, the search results may be randomly displayed.

(5) Second Presenting Operation

As an exemplary presenting operation, when the restaurant-information presenting section 107 receives a request to present information about restaurants from the user 6, the restaurant-information presenting section 107 obtains the feature value of the user from the user-visited-restaurant feature-value information 113, and specifies restaurants having a feature value close to the feature value of the user from the restaurant feature-value information 112. As restaurants which suit preferences of the user, information about the restaurants are presented.

Also in the “second presenting operation”, as in “first presenting operation”, search keywords may be accepted.

In another example, the restaurant-information presenting section 107 may obtain the feature value of a restaurant selected by a user from the restaurant feature-value information 112, obtain restaurants having a feature value close to that of the selected restaurant from the restaurant feature-value information 112, and present information about the restaurants as those which suit preferences of the user.

In response to a request to present information about restaurants from the user 6, the restaurant-information presenting section 107 may obtain the restaurant introduction information 30 for each of the restaurants from the restaurant introduction site DB 3, and calculate closeness of the feature values of the restaurants. Alternatively, the restaurant-information presenting section 107 may calculate closeness of the restaurants every predetermined period (such as one day or one week).

Each of the operations “first presenting operation” and “second presenting operation” described above has a different required configuration. However, both of the configurations may be combined with each other. Alternatively, a required configuration may be selected from each of the configurations so that a new configuration is constructed.

### Other Exemplary Embodiments

The present invention is not limited to the above-described exemplary embodiment, and various modifications may be made without departing from the gist of the present invention.

For example, in the above-described exemplary embodiment, as a concept about restaurants, “food ingredient”, “taste”, or a broader concept, “dish name” or “food genre”, is used. Not only a concept about restaurants but also a concept about lodging facilities, Internet shops, tourist attractions, golf courses, or the like may be used. Examples of a concept about lodging facilities include “service”, “meal”, and a broader concept such as “facilities”.

In the above-described exemplary embodiment, a feature value is calculated for each of the restaurants. A feature value may be calculated for each of products or each of services. For example, a feature value may be calculated for each dish served in a restaurant or each service provided in a lodging facility. In this case, information about a restaurant is replaced with information about a product or a service in a scope in which the gist of the present invention is not changed. For example, the user-visit history information 31 will be history information of actual purchase or use (eating) of products or services (hereinafter referred to as “products or the like”). Products or the like which are not actually purchased or used (eaten) may be utilized. For example, product pages or the like which are registered as Favorites by a user or a history of visits to a page in an introduction site for introducing products or the like may be used.

In the above-described exemplary embodiment, the functions of the units 100 to 107 of the controller 10 are achieved by using programs. All or some of the units may be achieved through hardware such as an application-specific integrated circuit (ASIC). In addition, the programs used in the above-described exemplary embodiment may be provided by storing them in a recording medium such as a compact disc-read-only memory (CD-ROM). Further, replacement, deletion, addition, or the like of steps described in the above-described exemplary embodiment may be made in a scope in which the gist of the present invention is not changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for presenting information, the process comprising:
extracting text information for each of a plurality of shops from introductory information about the plurality of shops from a predetermined viewpoint;
calculating a feature value for each of the plurality of shops from the extracted text information; and
presenting information about the plurality of shops in accordance with presentation order based on the calculated feature values.

2. The non-transitory computer readable medium according to claim 1,
wherein the text information is further extracted from a viewpoint of a broader concept or a narrower concept of the predetermined viewpoint.

3. The non-transitory computer readable medium according to claim 1,
wherein a first food ingredient name is extracted from the introductory information, the first food ingredient name being registered in advance as the text information extracted from the predetermined viewpoint.

4. The non-transitory computer readable medium according to claim 2,
wherein a first food ingredient name is extracted from the introductory information, the first food ingredient name being registered in advance as the text information extracted from the predetermined viewpoint.

5. The non-transitory computer readable medium according to claim 1,
wherein, on a basis of the feature value of a shop associated with a user using the introductory information or on a basis of the feature value of a shop selected by the user, the information about any of the plurality of shops is presented to the user.

6. The non-transitory computer readable medium according to claim 2,
wherein, on a basis of the feature value of a shop associated with a user using the introductory information or on a basis of the feature value of a shop selected by the user, the information about any of the plurality of shops is presented to the user.

7. The non-transitory computer readable medium according to claim 3,
wherein, on a basis of the feature value of a shop associated with a user using the introductory information or on a basis of the feature value of a shop selected by the user, the information about any of the plurality of shops is presented to the user.

8. The non-transitory computer readable medium according to claim 4,
wherein, on a basis of the feature value of a shop associated with a user using the introductory information or on a basis of the feature value of a shop selected by the user, the information about any of the plurality of shops is presented to the user.

9. The non-transitory computer readable medium according to claim 5, the process further comprising:
extracting a second food ingredient name from recipe information representing a recipe of a dish, and registering the second food ingredient name as the text information that is to be extracted.

10. The non-transitory computer readable medium according to claim 6, the process further comprising:
extracting a second food ingredient name from recipe information representing a recipe of a dish, and registering the second food ingredient name as the text information that is to be extracted.

11. The non-transitory computer readable medium according to claim 7, the process further comprising:
extracting a second food ingredient name from recipe information representing a recipe of a dish, and registering the second food ingredient name as the text information that is to be extracted.

12. The non-transitory computer readable medium according to claim 8, the process further comprising:
extracting a second food ingredient name from recipe information representing a recipe of a dish, and registering the second food ingredient name as the text information that is to be extracted.

13. A non-transitory computer readable medium storing a program causing a computer to execute a process for presenting information, the process comprising:
extracting text information for each of a plurality of products or services from introductory information about the plurality of products or services from a predetermined viewpoint;
calculating a feature value for each of the plurality of products or services from the extracted text information; and
presenting information about the plurality of products or services in accordance with presentation order based on the calculated feature values.

14. An information processing apparatus comprising:
an extracting section that extracts text information for each of a plurality of shops from introductory information about the plurality of shops from a predetermined viewpoint;
a calculating section that calculates a feature value for each of the plurality of shops from the text information extracted by the extracting section; and
an information presenting section that presents information about the plurality of shops in accordance with presentation order based on the feature values calculated by the calculating section.
